(19) United States
(12) Patent Application Publication
(10) Pub. No.: US 2011/0096861 A1
(43) Pub. Date: Apr. 28, 2011

(54) LOW COMPLEXITY METHOD AND APPARATUS TO APPEND A CYCLIC EXTENSION TO A CONTINUOUS PHASE MODULATION (CPM) SIGNAL

(75) Inventor: Marilyn P. Green, Pomona, NY (US)

(73) Assignee: NOKIA CORPORATION, Espoo, FI (FI)

(21) Appl. No.: 12/097,320

(22) PCT Filed: Dec. 16, 2005
(86) PCT No.: PCT/IB05/03845

§ 371 Date: Mar. 20, 2009

(51) Int. Cl. H04L 27/00

(52) U.S. Cl. 375/295

(57) ABSTRACT

The present invention provides a new and unique method and apparatus for cyclically extending a continuous phase modulation (CPM) block, which features transmitting each information symbol and its antipodal counterpart in any order within a data portion of the continuous phase modulation block. The continuous phase modulation block includes a sequence of N/2 M-ary information symbols that are spread over N symbol intervals, and the cyclic extension includes the first G M-ary symbols sent in the data portion of the block being appended to the continuous phase modulation block.

### BACKGROUND OF THE INVENTION

1. Field of Invention

The present invention is related to a method and apparatus for cyclically extending a Continuous Phase Modulation (CPM) signal; and more particularly, is related to a method and apparatus for cyclically extending a CPM signal in a high speed wireless packet network such as that set forth in the IEEE 802.16e Standard for wireless Metropolitan Area Network (MAN) technology.

2. Description of Related Art

Orthogonal Frequency Division Multiplexing (OFDM) transmission schemes are a well known in the art for transmitting data in broadband multi-user communications systems and network, as well as other known systems and networks, and was first introduced as a means of counteracting channel-induced linear distortions encountered when transmitting over a dispersive radio channel. See L. Hanzo, et al., “OFDM and MC-CDMA for Broadband Multi-User Communications, WLANs and Broadcasting,” J. Wiley & Sons, Ltd., 2004; as well as A. Bahai et al., “Multi-Carrier Digital Communications Theory and Applications of OFDM”, 2nd Ed., Springer Science and Business, Inc. 2004.

For such OFDM transmission schemes, inter-symbol interference (ISI) and inter-carrier interference (ICI) can be removed at the receiver by adding a cyclic guard interval and a cyclic prefix to the time-domain transmitted signal. This is accomplished by pre-pending a certain number of the ending data vector to the beginning of the OFDM symbol (or, equivalently, by appending a certain number of the beginning data vector to the end of the OFDM symbol). If the guard interval is longer in duration than the channel's impulse response, then each sub-carrier will appear to have passed through a flat fading channel. Consequently, the receiver can exploit the cyclic shift properties of the Discrete Fourier Transform (DFT) to significantly reduce the complexity of frequency domain equalization (FDE) techniques.

For example, FIG. 1 shows blocks of data 6, 8 having cyclic extensions 10, 12 postfixed thereon in relation to corresponding blocks of data 13, 15 having cyclic extensions 14, 16 prefixed thereon. When transmitted, each block of data is linearly convolved with the channel. By adding the cyclic extension (prefix or postfix) to each block, one can make the linear convolution between the block and the channel appear to be a circular convolution if the length of the guard interval exceeds the impulse response length of the channel. In the frequency domain, one can implement a single-tap channel equalizer at each frequency. This technique is well known for OFDM-based communications networks and systems and, more recently, for single-carrier systems. It has only recently been considered for CPM-based applications. In FIG. 1, there is a window (L . . . G) over which the FFT window may start. As long an Nk-point FFT is taken (N data symbols/block and k samples/symbol), one can obtain an identical receiver output.

Moreover, DFT-based SC-FDE (Single-Carrier FDE) techniques have only recently been applied to Continuous Phase Modulation (CPM) systems. For the purpose of understanding the invention that is discussed herein, CPM is summarized and characterized as follows: Over the nth symbol interval, a binary single-h CPM waveform can be expressed as

$$s ( t , a , h ) = exp \{ j 2 π h {\sum }_{i = - ∞}^{n} {I}_{i} q ( t - iT ) \} , nT \leq t < ( n + 1 ) T , \qquad ( 1 )$$

where T denotes the symbol duration, Iᵢ∈ {±1} are the binary data bits and h is the modulation index. The phase function, q(t), is the integral of the frequency function, f(t), which is zero outside of the time interval (0,LT) and which is scaled such that

$${\int }_{0}^{LT} f ( τ ) d τ = q ( LT ) = \frac{1}{2} . \qquad ( 2 )$$

An M-ary single-h CPM waveform is the logical extension of the binary single-h case in which the information symbols are now multi-level: i.e., Iᵢ∈ {±1, ±3, . . . , ±(M−1)}. Usually, M is selected to be an even number. However, it is noted that other alphabets are possible (and can also be used with this invention). For example, M can be odd or the alphabet can include zero—i.e. Iᵢ∈ {0, ±1, ±3, . . . , ±(M−1)}. The only restriction is that the alphabet contains an element and its antipodal counterpart. Finally, an M-ary multi-h CPM waveform can be written as

$$s ( t , I , h ) = exp \{ j2π {\sum }_{i = - ∞}^{n} {I}_{i} {h}_{{( i )}_{J}} q ( t - iT ) \} , nT \leq t < ( n + 1 ) T . \qquad ( 3 )$$

Typically, Iᵢ∈ {±1, ±3, . . . , ±(M−1)} (M even). However, there is no restriction to this particular alphabet and M can even be odd, as mentioned earlier. Typically, the modulation index cycles through a set of J values: h∈ {h₀ . . . h_{J-1}} and so (i)_{J} denotes “i mod J”. The expression in (3) may also be written as:

$$s ( t , a , h ) = exp \{ j ( {θ}_{n - L} + 2 π {\sum }_{i = 0}^{L - 1} {I}_{n - i} {h}_{{( n - i )}_{J}} q ( t - ( n - i ) T ) \} \qquad ( 4 )$$

The phase state,

$${θ}_{n - L} = π {\sum }_{i = - ∞}^{n - L} {I}_{i} {h}_{{( i )}_{J}} mod 2 π$$

determines the contribution of the symbols for which the phase function has reached its final constant value of one half.

However, when applying such DFT-based SC-FDE techniques to CPM systems, some issues have developed. Since the CPM waveform signal is supposed to have a continuous phase, one cannot simply append a cyclic extension at the end or beginning of a data block. FIG. 2 shows an example of a blind introduction of a cyclic extension, which can destroy the continuous phase property of the CPM waveform signal. If the wrong cyclic postfix is appended to a CPM waveform, the phase would become discontinuous, which results in expansion of the signal bandwidth and a reduction in spectral efficiency. In effect, when pre-pending or appending the cyclic extension to the CPM waveform, care must be taken in order to maintain phase continuity.

One approach for appending a cyclic extension to CPM block transmissions is to insert special data-dependent symbols (“channel” or “tail” symbols) into the data portion of the CPM transmission block. The inclusion of these special symbols allows the transmitter to repeat the data in a cyclic extension without destroying the continuous phase property of the signal. However, these “channel” symbols, which are calculated based on past observations, must either be computed on a block-by-block basis or determined by using a table-lookup in order to map a particular sequence of observed symbols to the required “channel” symbol sequence. In addition, since they are data-dependent, the actual number of “channel” bits that are needed may vary from block to block. Simple approaches exist for constructing the “tail” bits for binary single-h CPM systems, but no one has provided a general, low complexity solution for M-ary multi-h CPM.

### Detailed Discussion of Known Techniques for Solving the CPM Phase Continuity Problem

The following is a detailed discussion of known techniques for solving the phase continuity problem:

The first technique is set forth in Jun Tan and Gordon L. Stüber, “Frequency Domain Equalization for Continuous Phase Modulation”, accepted for publication in the IEEE Transactions in Wireless Communications, where Tan and Stüber investigate various approaches for applying SC-FDE to binary single-h CPM block transmissions that have cyclic extensions. In their approach, the transmitter prepends a length-G cyclic prefix to the data block, where G equals or exceeds the maximum expected channel length. The total block length, including the data and the cyclic prefix, is N+G, where N denotes the size of the data portion of the block (including “tail” bits), as shown in FIG. 3.

In order to facilitate their analysis, they use Rimoldi's “tilted-phase” representation for CPM, as set forth in Bixio Rimoldi, “A Decomposition Approach to CPM”, IEEE Transactions on Information Theory, Vol. 34, No. 2, March 1988, which models CPM as a Continuous Phase Encoder (which resembles a convolutional encoder) followed by a memory-less modulator.

In order to ensure phase continuity when the cyclic prefix is used, they force the tilted phase trellis to always begin and end with the zero state. Thus, in their solution, the trellis path must return to zero when n=N−G. This is accomplished by using lₜ tail symbols x_{N-G-l}_{ₜ}₊₁, x_{N-G-l}_{ₜ}₊₂, . . . , x_{N-G} to flush the state memory of the CPE so that it returns the encoder to the zero state at N−G. The length lₜ depends on the tilted phase trellis structure, and is equal to the maximum number of inputs needed to return the path to the zero state from any other trellis state. Binary response CPM with h=Q/P (Q and P integers) requires the number of tail bits to satisfy the equation: lₜ≧ₘₐₓ{L,P−1} M-ary partial-response with h=Q/P requires that

$${l}_{t} \geq max \{ L , ⌈ \frac{P - 1}{M - 1} ⌉ \} .$$

( ┌x┐) is the smallest integer greater than or equal to x).

At the end of the data block, a second length-lₜ tail sequence is used to ensure that the last state is the zero state. Thus, out of the length-N symbol sequence, {xₙ}, there are 2lₜ tail symbols and N−2lₜ information symbols. After insertion of the tail bits, the cyclic prefix is pre-pended by copying the last G symbols of {xₙ} to the beginning of the block. Thus, the symbol sequence, with guard interval included is

x̅ₙ=x₍ₙ₎_{_{N}}, n=−G,−G+1, . . . , −1,0,1, . . . , N−1, (5)

where (n)_{N} is the residue of n modulo-N and the length-(N+G) sequence is applied to the CPM modulator that begins in the zero-state. Because of the tail symbols, the path through the tilted phase trellis starts at the zero state when n=−G and returns to the zero state at epochs n=−1, n=N−G, and n=N−1. The trellis path from n=−G to n=−1 is identical to that from n=N−G to n=N−1.

Although Tan and Stüber do provide one simple example of how to solve for the tail bits when the transmitter uses GMSK (which is a form of binary single-h CPM), they do not discuss a general solution to this problem. The problem is that there is no way to formulate a simple, general solution for M-ary multi-h CPM and since the number of tail bits is data dependent, the number of them will vary from block to block.

The problem with the Stuber and Tan is easily understood by considering the following hypothetical scenario (and referring to FIG. 3): Stuber and Tan look at all possible system states and they determine that the maximum number of tail bits required to return the system to the zero state from any other state is equal to 5. Then, they fix the size of the two tail bit sections TB₁, TB₂ (FIG. 3) to be equal to 5. However, suppose that they want to transmit N−10 data bits which only requires 3 tail bits in the section labelled TB₁ of FIG. 3 and 2 tail bits in the section labelled TB₂ of FIG. 3 to return the system to the zero state. If they simply “stuff” the un-needed tail bit slots with “dummy bits”, then they will be generating two entirely new data sequences preceding the tail sections and they will most likely need a different sequence of tail bits to return the system to the zero state. They may even need a different number of tail bits to return the system to the zero state. So, in order to create their cyclic extension, Stuber and Tan will have to make the tail section variable which results in a more complex receiver design, which results in the block size being variable, and which results in the receiver having to be told the block size being used (i.e. causing less bandwidth efficiency). Because of this, it appears that their solution cannot be used in a practical system unless they change the transmission to be non-Mary (i.e. by including zeros in the symbol alphabet).

In F. Pancaldi and G. M. Vitetta, “Equalization Algorithms in the Frequency Domain for CPM Signals”, March 2004, pp. 1-26, Pancaldi and Vitetta develop FDE algorithms for binary single-h CPM. Their algorithms require a cyclic extension of the transmitted CPM data blocks. Phase continuity is preserved by the use of K “channel” bits that are inserted in the data portion of the block. These special bits are computed based on bits in the previous and current block. Although some of the bits can be calculated directly, Pancaldi and Vitetti note that there remain K−L+1 bits (where L denotes the memory of the CPM waveform) that must be selected such that their sum (mod 2π) satisfies the following constraint

$$π h {\sum }_{i = 0}^{K - L} {a}_{N - K + k}^{( l )} = {ξ}_{l} , \qquad ( 6 )$$

where ζₗ=θ_{N}_{_{T}}^{(l-1)}−θ_{N-K+(L-1)}^{(l)}, θₘ^{k} denotes the phase state during the m-th symbol interval of the k-th data block, N_{T} denotes the total block length (which includes the cyclic prefix and the data portion of the block), and N denotes the length of the first three sub-blocks (which include the cyclic prefix, a data portion and the K “channel” bits) of a block. Pancaldi and Vitetta recommend that the solution be memorized in a read-only memory for any possible value of ζ₁ at the transmitter.

In general, this may be a complex problem to solve and it is noted that the generalization of this result to M-ary multi-h CPM further increases its complexity.

### Need for a Solution

Finally, there is a need for a better approach to solve the aforementioned phase continuity problem for the following reasons: There has been a revival of interest in CPM signaling as an alternative to OFDM because of its spectral efficiency and because it's constant envelope property allows it to be used with less costly non-linear amplifiers without any signal distortion. In addition, future standards for networks like that for IEEE 802.16e, CDMA and GSM based networks, may develop special modes that promote the use of CPM waveforms. Moreover, with the rising popularity of DFT-based SC-FDE techniques and the recent interest in extending these techniques to CPM waveforms, it should be expected that any future standard that incorporates CPM will construct specifications for how the transmitter should incorporate a cyclic extension (prefix or postfix) into the CPM waveform. Since the current state of the art discussed above requires the CPM transmitter to do calculations based on past symbols or to do a table-lookup in order to create a cyclic extension, there is need for a simpler method that does not require any calculations or table look-up and which could conceivably be adopted as an alternative method by a future standards body.

### SUMMARY OF THE INVENTION

This invention provides a new and unique method and apparatus to append a cyclic extension to a continuous phase modulation (CPM) block, which features transmitting each information symbol and its antipodal counterpart in any order within a data portion of the continuous phase modulation block. In operation, the continuous phase modulation block may include a sequence of N/2 M-ary information symbols that are spread over N symbol intervals, the cyclic extension may include the first G M-ary symbols sent in the data portion of the block being appended to the continuous phase modulation block, and the same modulation index is used for each information symbol and its antipodal counterpart.

The present invention preserves the continuous phase property of a CPM waveform signal, and provides a solution that is low in complexity, which makes it particularly attractive for use in uplink signalling applications in broadband multi-user communication networks, WLANs and other suitable communication networks when battery power may be one of the most important concerns. Furthermore, according to the present invention, there is no need to formally calculate the data-dependent symbols, either from past information symbols or from a table-lookup. Hence, it represents a lower complexity alternative to the current state of the art. Finally, the present invention facilitates the use of DFT-based SC-FDE techniques by the CPM receiver, which leads to a lower complexity for channel equalization.

The present invention also introduces redundancy into the transmission block which may lead (under certain channel conditions) to improved receiver performance vis-à-vis other CPM schemes that do not incorporate any form of redundancy. Thus, implementation of this invention can potentially achieve similar advantages as those gained by other systems that employ spreading techniques at the expense of a lower data rate (such as conjugate-symmetric OFDM).

The present invention provides a low complexity method and apparatus to append a cyclic extension to a CPM block so that the receiver can equalize the channel using DFT-based linear SC-FDE receiver techniques, by spreading spread an arbitrary sequence of N/2 M-ary information symbols—{I₀, I₁, . . . I_{N/2-1}}—over N symbol intervals such that a CPM transmitter can append the cyclic extension without having to calculate any special “channel” symbols. By doing so, the present invention makes the cyclic extension of CPM block transmissions as straightforward to implement as it is in linearly modulated systems, such as OFDM.

By transmitting each information symbol and its antipodal counterpart (i.e. Iₙ and −Iₙ) in any order within the data portion of the block, one can force the CPM waveform to return to its initial phase state (which is observed at the beginning of the data block) after N symbols have been transmitted. It follows that once the phase has returned to its initial state, that the cyclic postfix can be appended to the end of the information sequence without disrupting the phase continuity of the waveform. Within the scope of the present invention, there are countless ways to transmit the sequence of information symbols and their antipodal counterparts within the same data block. In one special implementation, for example, the N symbols and the corresponding modulation indices that are used for the CPM block transmission can be constructed follows:

$$x = \{ \underbrace{{I}_{0} , {I}_{1} , … , {I}_{N / 2 - 1} , - {I}_{N / 2 - 1} , … , - {I}_{1} , - {I}_{0}}_{N Data Symbols} , \underbrace{{I}_{0} , {I}_{1} , … , {I}_{G - 1}}_{Length \text{-} G Cyclic Extension} \} \\ h = \{ \underbrace{{h}_{{( 0 )}_{J}} , {h}_{{( 1 )}_{J}} , … , {h}_{{( N / 2 - 1 )}_{J}} , {h}_{{( N / 2 - 1 )}_{J}} , … , {h}_{{( 1 )}_{J}} , {h}_{{( 0 )}_{J}}}_{Length \text{-} N Sequence} , \underbrace{{h}_{{( 0 )}_{J}} , {h}_{{( 1 )}_{J}} , … , {h}_{{( G - 1 )}_{J}}}_{Length \text{-} G Cyclic Extension} \} \qquad ( 7 )$$

The notation (n)_{J} denotes n mod J. In this special implementation, one may assume that over the first N/2 symbol intervals that the modulation index is allowed to cycle through its J values {h_{J}, . . . , h_{J-1}}, or to assume its values over the first N/2 symbol intervals according to rules that are predefined by a system specification. Over the next N/2 symbol intervals, the modulation indices are reversed. This effectively constrains each symbol and its antipodal counterpart to use the same modulation index.

In general, as long as the same modulation index is used for Iₙ and for its antipodal counterpart −Iₙ, one can force the phase to return to its initial state after N symbol intervals.

In effect, the present invention is based of the following observation that if Φ(t) is a periodic function with period NT, then Φ(t) mod 2π is also periodic with a period that is an integer multiple of NT. As discussed above, the CPM waveform signal that has a periodic argument can be expressed as:

$$s ( t ) = exp ( jΦ ( t ) ) \\ Φ ( t ) = 2 π {\sum }_{i = - ∞}^{∞} {h}_{{( i )}_{J}} {I}_{{( i )}_{N}} q ( t - iT ) \qquad ( 8 )$$

However, in order to solve the CPM phase continuity problem, one does not require periodicity over all time. Instead, one simply wants to force the CPM waveform signal to appear to be periodic during the k-th block (kT, kT+NT+GT), where N denotes the number of M-ary symbols sent in the data portion of the block and G denotes the length of the cyclic extension.

In view of this, the present invention may be implemented by:

1. Fixing J (the number of modulation indices in a multi-h scheme) to be a factor of N. Otherwise, Φ(t) mod 2π will have a period that is >NT.

2. Transmitting N/2 M-ary symbols and their N/2 antipodal counterparts in any order within the block. This forces the cumulative phase argument to always sum to zero every N symbols as long as the modulation index used with an M-ary symbol is also used with its antipodal counterpart. The time-varying part of the phase argument will repeat as well after N symbols.

3. Appending the first G M-ary symbols sent in the data portion of the block as the cyclic extension.

In order to add a cyclic extension (postfix) to the signal without disrupting the continuous phase property of the signal, a length-N data block is transmitted that contains N/2 M-ary symbols and their antipodal counterparts in any order. Hence, the block contains:

{I₀, I₁, . . . , I_{N/2-1}}, {−I_{N/2-1}, −I_{N/2-2}, . . . , −I₀}

The associated modulation indices (which cycle through J different values) are:

{h₍₀₎_{_{J}}, h₍₁₎_{_{J}}, . . . , h_{(N/2-1)}_{_{J}}}, {h_{(N/2-1)}_{_{J}}, . . . , h₍₁₎_{_{J}}, h₍₀₎_{_{J}}}^{→(n)}^{_{J}} ^{denotes n mod J}

This causes the phase state to always return to its initial value after N M-ary symbols have been sent, which is the preface required to create a cyclic extension without disrupting the signal's phase.

So after transmitting N M-ary symbols, the first G symbols sent in the data portion of the block are appended as the cyclic extension. For example, the symbols transmitted may be in the following order:

$$\{ \underbrace{{I}_{0} , {I}_{1} , … , {I}_{N / 2 - 1} , - {I}_{N / 2 - 1} , - {I}_{N / 2 - 2} , … , - {I}_{0}}_{NM \text{-} arySymbols} , \underbrace{{I}_{0} , {I}_{1} , … , {I}_{G - 1}}_{\begin{matrix}Length G Cyclic \\ Extension\end{matrix}} \}$$

The present invention is flexible and can be used to construct a cyclic postfix extension or a cyclic prefix extension.

The present invention also includes a wireless network having a network node, point or element with a module to append a cyclic extension to a continuous phase modulation (CPM) block, wherein each information symbol and its antipodal counterpart is transmitted in any order within a data portion of the continuous phase modulation block. The wireless network may take the form of a Metropolitan Area Network (MAN) including that set forth according to the IEEE 802.16e Specification, as well as some other suitable network based on one or more of the 3GPP2, GSM, OFDM or CDMA network configurations.

The present invention also includes a network node, point or element, such as a CPM transmitter or a CPM receiver, having corresponding low complexity cyclic extension modules for respectively transmitting, receiving and/or processing the CPM transmission block according to the present invention.

The present invention also includes a computer program product with a program code, which program code is stored on a machine readable carrier, for carrying out the steps of a method comprising one or more steps for or transmitting each information symbol and its antipodal counterpart in any order within a data portion of the continuous phase modulation block, when the computer program is run in a module of either a network node, point or element in a wireless network.

The present invention also includes implementing the one or more steps of the method via a computer program running in a processor, controller or other suitable module in one or more network nodes, points, terminals or elements in the wireless network.

In summary, the method or apparatus according to the present invention appends a cyclic extension to a CPM transmission block in a manner that preserves the continuous phase property of the signal. In general, if the data is sent in any order, then the invention allows one to append a cyclic postfix; however, if the data symbols are transmitted in a specific order, then the invention allows for the construction of a cyclic prefix as well. Moreover, the present invention provides a solution that is low in complexity, that is ideal for uplink transmissions, where battery life is important and that makes the cyclic extension of CPM as simple to implement as it is for OFDM and other, linear single-carrier systems. Moreover, the present invention does not require the transmitter to calculate any “channel” symbols. Hence, it represents a lower complexity alternative to the current state of the art, is applicable to any form of CPM, whereas the state of the art solutions have focused on binary single-h CPM, and this invention also allows one to use a fixed block size whereas the Stuber/Tan solution does not if they transmit M-ary (no 0's in the alphabet). Moreover, the present invention facilitates the use of DFT-based SC-FDE techniques at the receiver, and could conceivably be a part of future standards for a “low-complexity, low-power” mode.

Furthermore, the present invention advantageously introduces redundancy into the transmission block which may lead (under certain channel conditions) to improved receiver performance vis-à-vis other CPM schemes that do not incorporate any form of redundancy. Thus, implementation of this invention can potentially achieve similar advantages as those gained by other systems that employ spreading techniques at the expense of a lower data rate (such as conjugate-symmetric OFDM). Although there is a symbol rate reduction of ½, this invention may still offer a higher data rate and better spectral efficiency than any of the published approaches to the construction of cyclic prefixes for CPM because those solutions rely on the use of BINARY single-h CPM. The MBOA's (Multiband OFDM Alliance's) MB-OFDM (Multi-Band OFDM) UWB radio has a specification which is widely accepted by the UWB industry (802.15.3a proposal). In its 53.3, 55 and 80 Mbps data modes, sends each conjugate-symmetric OFDM symbol over two consecutive time slots. This represents a spreading factor of 4. In addition, for all other data modes below 480 Mbps, the MBOA MB-OFDM UWB radio uses conjugate symmetry. This represents a spreading factor of 2. Thus, this is a good example of the use of redundancy at the transmitter being acceptable as an industry standard.

### BRIEF DESCRIPTION OF THE DRAWING

The drawing includes the following Figures, which are not necessarily drawn to scale:

FIG. 1 shows an illustration of one block of data, which has been constructed to have either a cyclic postfix or prefix, and the window over which the signal may be processed to obtain an equivalent receiver output.

FIG. 2 shows an example of a blind introduction of a cyclic extension, which can destroy the continuous phase property of the CPM waveform signal.

FIG. 3 shows a diagram of one CPM block (which is an example of the prior art system that has been designed for a binary single-h CPM system) having N bits or symbols and a cyclic prefix.

FIG. 4 shows a cyclically extended 4-ary CPM with h=[ 1/16].

FIG. 5 shows a cyclically extended 4-ary CPM with h=¼, N=32 and G=16.

FIG. 6 shows a cyclically extended 4-ary CPM with h=[¼, 1/16], N=32 and G=16.

FIG. 7, including FIGS. 7a and 7b, shows an interpretation of the received signal as having either a cyclic prefix or postfix when the M-ary symbols are sent in a special order.

FIG. 8 shows a block diagram of an IEEE 802.16e simple campus configuration which may be adapted according to the present invention.

FIG. 9, including FIGS. 9a and 9b, shows a block diagram of a CPM transmitter and a CPM receiver according to the present invention.

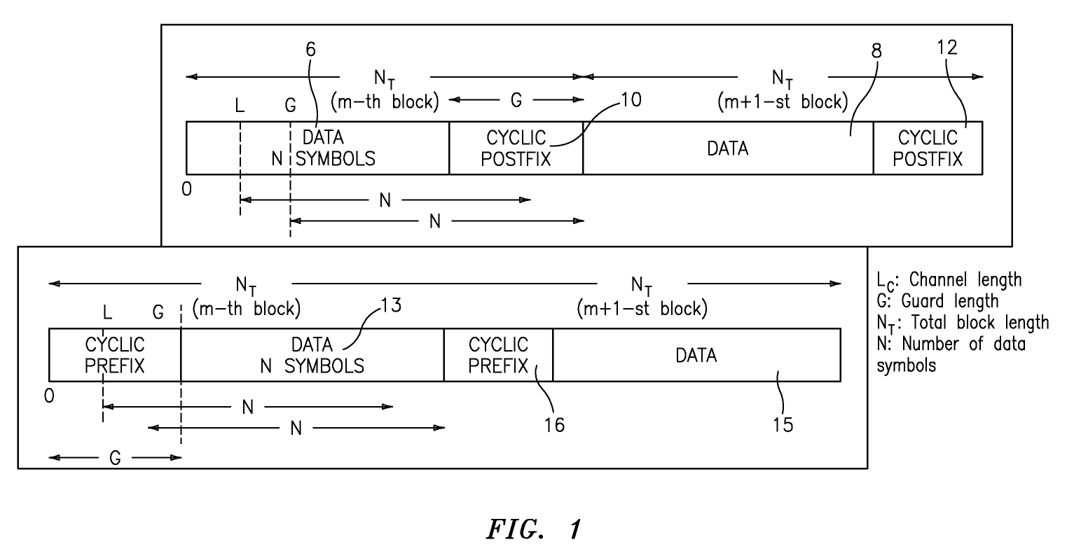

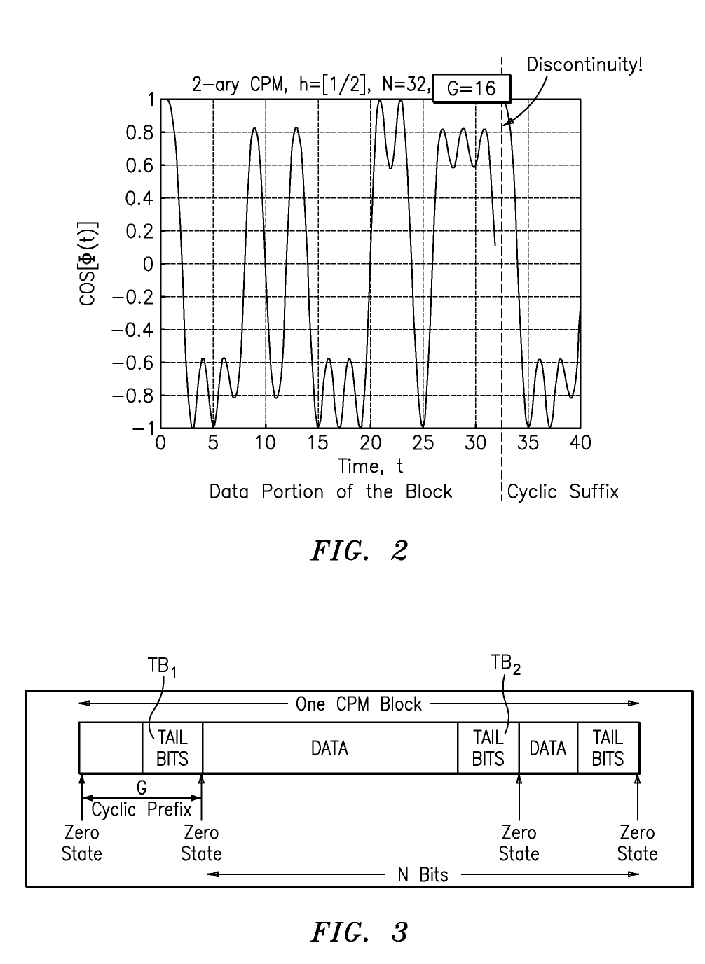

The description below also includes Figures showing various formats for illustrating the present invention.

### BEST MODE OF THE INVENTION

The present invention provides a new and unique method and apparatus to append a cyclic extension to a continuous phase modulation (CPM) block, featuring transmitting each information symbol and its antipodal counterpart in any order within a data portion of the continuous phase modulation block. In operation, the continuous phase modulation block may include a sequence of N/2 M-ary information symbols that are spread over N symbol intervals, the cyclic extension may include the first G M-ary symbols sent in the data portion of the block being appended to the continuous phase modulation block, and the same modulation index is used for each information symbol and its antipodal counterpart. The scope of the invention is intended to include embodiments where the same modulation indices used for the first G-symbols of the data portion of the continuous phase modulation block are used for the cyclic extension, as well as where the modulation index of the continuous phase modulation waveform is determined by the data being sent or other transmission rule.

### The Basic Implementation

In particular, the present invention generates a cyclic extension to a CPM waveform in the guard interval after each block transmission. Hence, it is first important to understand, quite generally, how one can force a CPM signal to repeat with a certain periodicity.

Forcing the CPM Phase Argument to be Periodic

Let one consider a special CPM waveform, s(t), which has as its argument, a periodic phase function:

$$s ( t ) = exp ( jΦ ( t ) ) \\ Φ ( t ) = 2 π {\sum }_{i = - ∞}^{∞} {h}_{{( i )}_{J}} {I}_{{( i )}_{N}} q ( t - iT ) \qquad ( 9 )$$

where I₍ᵢ₎_{_{N}} is an M-ary symbol from the periodic sequence {I₀, . . . , I_{N-1}}, h₍ᵢ₎_{_{N}} ∈ {h₀, . . . , h_{J-1}} is a modulation index from the periodic sequence {h₀, . . . , h_{J-1}}, and the notation (i)_{J} denotes i modulus J. The phase function, q(t) is defined as the integral of a frequency function, f(t):

$$q ( t ) = {\int }_{0}^{t} f ( τ ) d τ \\ q ( t ) = 1 / 2 for t \geq LT . \qquad ( 10 )$$

Since {I₀, . . . , I_{N-1}} and {h₀, . . . , h_{J-1}} are periodic, their product sequence h₍ᵢ₎_{_{J}}I₍ᵢ₎_{_{N}} is also a periodic sequence whose period will be an integer multiple of each of the individual periods, N and J.

Let one restrict J to be a factor of N. Then, it follows that the function Φ(t) is periodic over the interval NT and that the function Φ(t) mod 2π will also have a period that is an integer multiple of NT because the product sequence repeats itself after every N samples. For example, if one lets J=2 and N=4, then the product sequence will repeat after every N=4 samples, as shown below:

$$\{ … \underbrace{{h}_{0} {I}_{0} , {h}_{1} {I}_{1} , {h}_{0} {I}_{2} , {h}_{1} {I}_{3}}_{Fundamental Period} , {h}_{0} {I}_{0} , … \} . \qquad ( 11 )$$

The simplest method of determining the periodicity of Φ(t) mod 2π is to look at N terms of its argument, for which t-iT≧LT and to compute their sum mod 2π. This requires us to consider the cumulative phase term at the n-th and (n+N)-th symbol intervals:

$${θ}_{n - L} = ( π {\sum }_{i = - ∞}^{n - L} {h}_{{( i )}_{J}} {I}_{{( i )}_{N}} ) mod 2 π \\ \begin{matrix}{θ}_{n + N - L} = ( π {\sum }_{i = - ∞}^{n + N - L} {h}_{{( i )}_{J}} {I}_{{( i )}_{N}} ) mod 2 π \\ = ( π {\sum }_{i = - ∞}^{n - L} {h}_{{( i )}_{J}} {I}_{{( i )}_{N}} + {\sum }_{i = - ∞}^{n + N - L} {h}_{{( i )}_{J}} {I}_{{( i )}_{N}} ) mod 2 π\end{matrix} \qquad ( 12 )$$

In the last equation, the latter N-term sum is dependent on the product of two periodic sequences, and is guaranteed to be exactly equal to zero whenever

$${\sum }_{i = n - L + 1}^{n + N - L} {h}_{{( i )}_{J}} {I}_{{( i )}_{N}} = 0 \qquad ( 13 )$$

When this sum is equal to zero, then the function Φ(t) mod 2π will be periodic over the interval NT since it will return to the same phase state after the observation of N symbols. This observation is of fundamental importance to the development of the present invention.

### Application to Cyclic Extension

The aforementioned description demonstrates that one can force the phase argument of the CPM waveform mod 2π to have a period of NT. In the discussion below, it is shown how this observation can be applied to CPM block transmissions in order to easily construct a cyclic extension.

One assume that the CPM system associates each interval of length (N+G)T with one block, where N denotes the number of symbols being sent and G denotes the number of symbols sent during the cyclic extension.

Forcing the summation in equation (12) to be equal to zero is easily accomplished if one takes the N-length transmission block and use it to transmit the following two length N/2 M-ary sequences:

{I₀, . . . , I_{N/2-1}}, {−I₀, . . . , −I_{N/2-1}}. (14)

There is no constraint on the order in which the elements of these two sets of symbols are to be placed within the data block. The only constraint is that the modulation index associated with Iₙ is also used with −Iₙ so that the summation in (12) is equal to zero.

In one implementation, for example, the N symbols transmitted in the data portion of the block can be expressed as:

yₙ=Iₙ n=0, . . . , N/2−1

yₙ=−I_{N-n-1} n=N/2, . . . , N−1 (15)

In order to create the cyclic extension, the transmitter can simply append the first G symbols, y₀, . . . , y_{G-1}, to the transmission block.

Continuing the present example from Eq. (14), the transmitter might arrange the M-ary symbols (and the modulation indices) within the l-th transmitted block as follows:

$$x = \{ \underbrace{… {I}_{G - 1}^{( l - 1 )}}_{( 1 - 1 ) \text{-} st Block} , \underbrace{\begin{matrix}{I}_{0}^{( l )} , {I}_{1}^{( l )} , … , {I}_{N / 2 - 1}^{( l )} , \\ - {I}_{N / 2 - 1}^{( l )} , … , - {I}_{1}^{( l )} , - {I}_{0}^{( l )}\end{matrix}}_{Data for the 1 \text{-} th Block} , \underbrace{{I}_{0}^{( l )} , {I}_{1}^{( l )} , … , {I}_{G - 1}^{( l )}}_{\begin{matrix}Cyclic Guard Interval \\ for the 1 \text{-} th Block\end{matrix}} , \underbrace{{I}_{0}^{( l + 1 )} , {I}_{1}^{( l + 1 )} , …}_{\begin{matrix}Data for the \\ ( 1 + 1 ) \text{-} st Block\end{matrix}} \} \\ h = \{ \underbrace{… {h}_{{( G - 1 )}_{J}}}_{( 1 - 1 ) \text{-} st Block} , \underbrace{\begin{matrix}{h}_{{( 0 )}_{J}} , {h}_{{( 1 )}_{J}} , … , {h}_{{( N / 2 - 1 )}_{J}} , \\ {h}_{{( N / 2 - 1 )}_{J}} , … , {h}_{{( 1 )}_{J}} , \\ {h}_{{( 0 )}_{J}} , {h}_{{( 0 )}_{J}} , {h}_{{( 1 )}_{J}} , … , {h}_{{( G - 1 )}_{J}}\end{matrix}}_{1 \text{-} th Block} , \underbrace{{h}_{{( 0 )}_{J}} , {h}_{{( 1 )}_{J}} , …}_{( 1 + 1 ) \text{-} st Block} \} . \qquad ( 16 )$$

It is noted that for this special arrangement of symbols within the data block (shown in Eq. (15)) that one can generate a cyclic prefix or postfix to the signal, depending on how one wants to process the signal. This property is revealed in the supporting figures discussed below.

### EXAMPLES

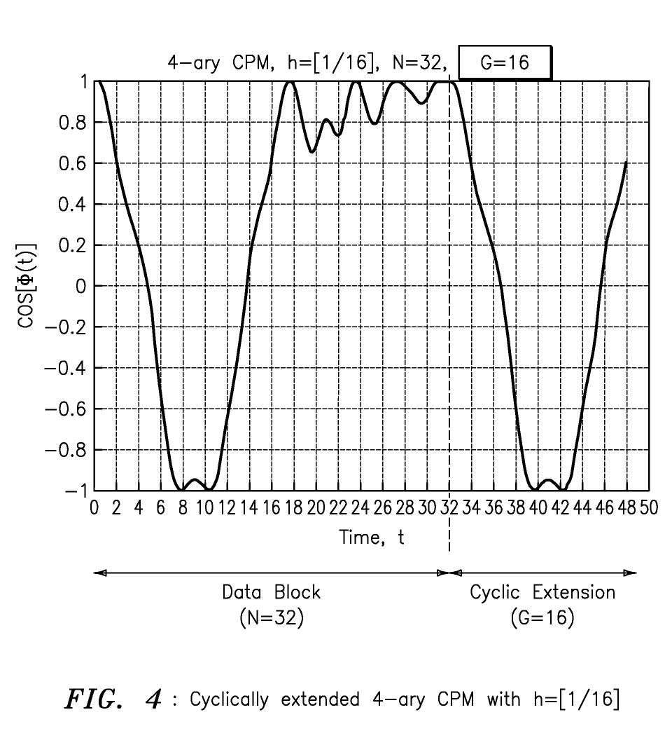

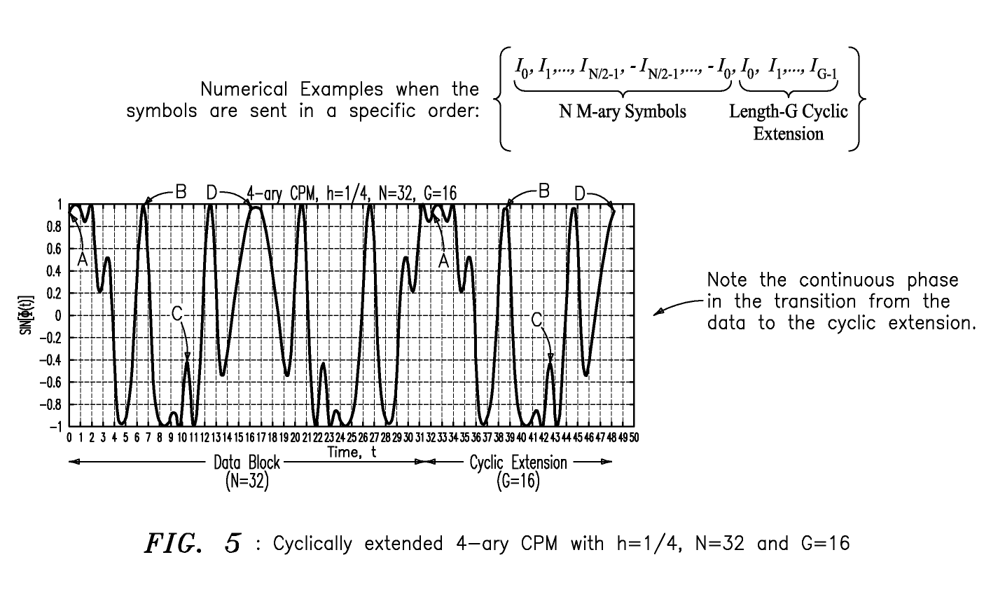

FIG. 4 shows a cyclically extended 4-ary CPM with h= 1/16. In this example, the M-ary symbols and their antipodal counterparts are sent in a random order within each data block, and phase continuity is preserved at the boundary between the data portion of the block and the cyclic extension, as shown.

FIG. 5 shows a cyclically extended 4-ary CPM with h=¼, N=32 and G=16, where N equals the size of the data portion of the block, G equals the size of the cyclic extension and J equals 1 (the number of modulation indices). FIG. 5 shows the imaginary part of the complex baseband CPM waveform that has been cyclically extended. The cyclic extension property also exists for the real part of the waveform, which is 4-ary CPM with h=¼, L=3, raised cosine. The CPM waveform signal has a continuous phase in the transition from the data to the cyclic extension.

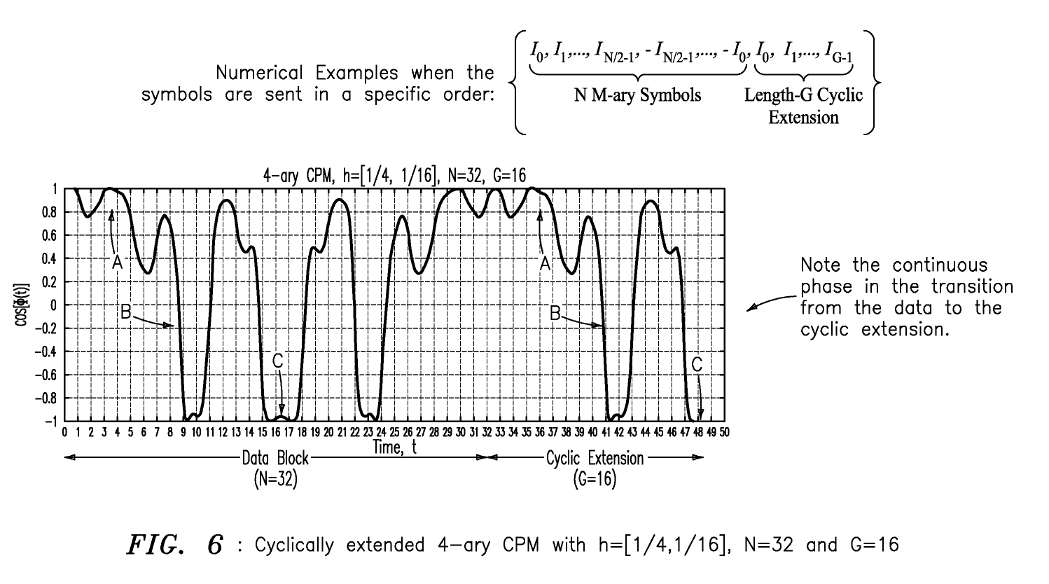

FIG. 6 shows a cyclically extended 4-ary CPM with h=[¼, 1/16], N=32 and G=16, where N equals the size of the data portion of the block, G equals the size of the cyclic extension, J equals 2 (the number of modulation indices). FIG. 6 shows the real part of the complex baseband CPM waveform that has been cyclically extended. The cyclic extension property also exists for the imaginary part of the waveform, which is 4-ary CPM with h=[¼, 1/16], L=3, raised cosine. The CPM waveform signal has a continuous phase is the transition from the data to the cyclic extension.

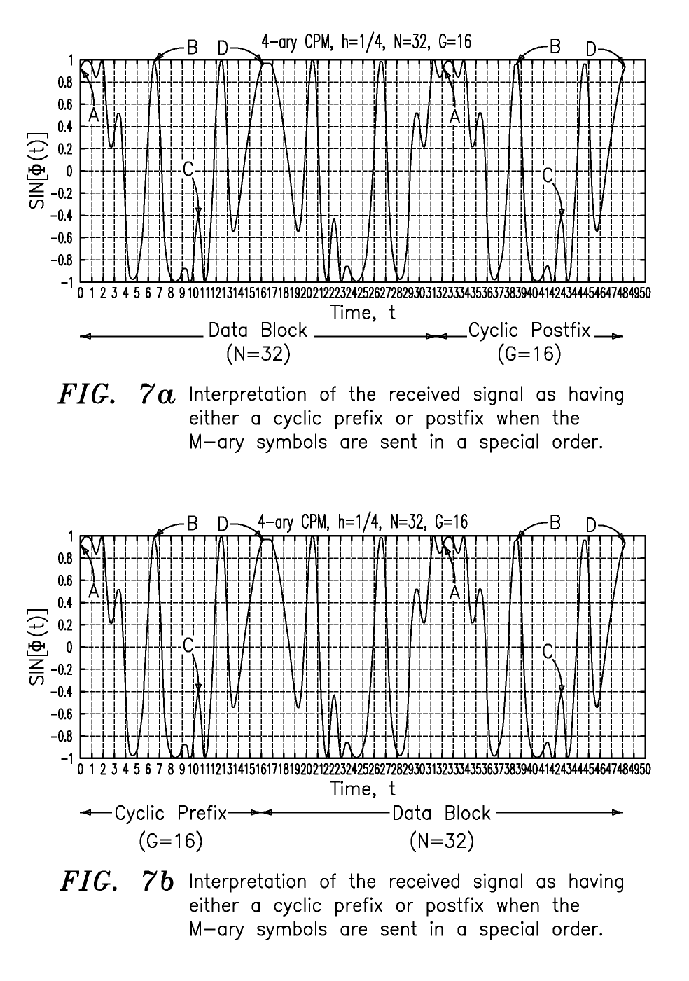

FIG. 7, including FIGS. 7a and 7b, shows interpretations of the received signal as having either a cyclic prefix or postfix when the M-ary symbols are sent in a special order. When the M-ary symbols are transmitted in the specific order:

$$\{ \underbrace{{I}_{0} , {I}_{1} , … , {I}_{N / 2 - 1} , - {I}_{N / 2 - 1} , - {I}_{N / 2 - 2} , … , - {I}_{0}}_{NM - arySymbols} , \underbrace{{I}_{0} , {I}_{1} , … , {I}_{G - 1}}_{\begin{matrix}Length G Cyclic \\ Extension\end{matrix}} \} ,$$

then one can process the same received signal as either having a cyclic postfix or a cyclic prefix, as shown in FIGS. 7a and 7b respectively.

### Applications

The present invention may be implemented is a wireless network having a network node, point or element with a module to append a cyclic extension to a continuous phase modulation (CPM) block, wherein each information symbol and its antipodal counterpart is transmitted in any order within a data portion of the continuous phase modulation block. The wireless network may take the form of a Metropolitan Area Network (MAN) including that set forth according to the IEEE 802.16e Specification, as well as some other suitable network based on one or more of the 3GPP2, GSM, OFDM or CDMA network configurations.

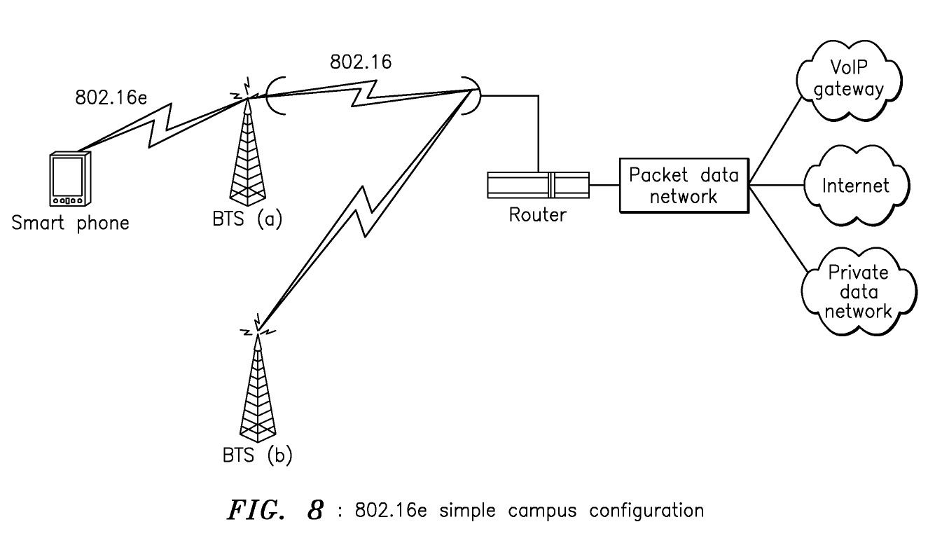

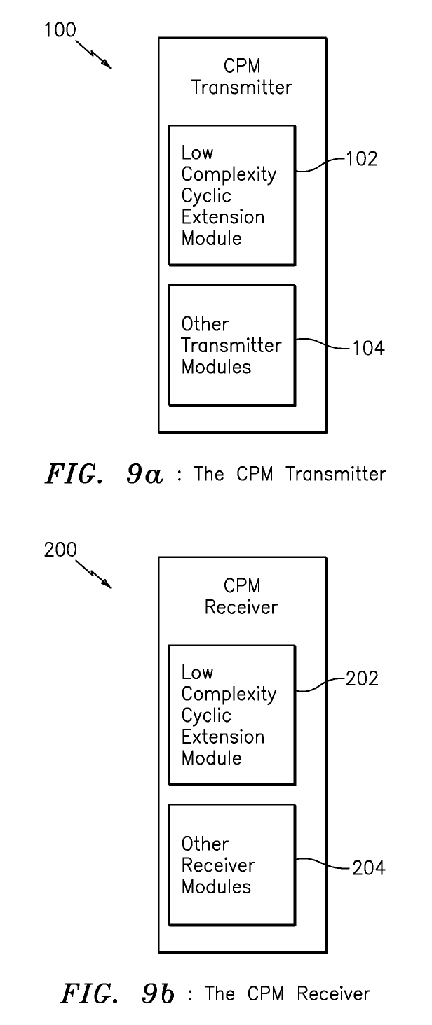

For example, FIG. 8 shows an example of one such network configuration in the form of an IEEE 802.16e simple campus configuration taken from Chapter 6 (FIG. 6.9) of C. Smith et al., “3G Wireless and WiMax and Wi-Fi 802.16 and 802.11,” The McGraw-Hill Companies, Inc. 2005, which illustrates a subscriber accessing the 2.5G/3G packet data network via one or more 802.16e broadband links that may be configured according to the present invention. In the IEEE 802.16e simple campus configuration in FIG. 8, the smart phone, the BTS(a), BTS(b) and router as shown could be implemented with transmitter and receivers according to the present invention, consistent with that shown in FIGS. 9a and 9b below.

The present invention may also be used as a part of the transmission specifications for a future standard (such as future IEEE 802.16e, GSM, OFDM or CDMA) that supports CPM as an alternative uplink modulation. The recent revival of interest in CPM, coupled with the popularity of DFT-based linear equalisation schemes, makes the present invention an important contribution for the design of low complexity CPM cyclic extension schemes.

The present invention may be used as a part of the Wimax project with the intention of introducing it into future IEEE 802.16e networks. In addition, embodiment are envisioned in which the present invention may be used in 3GPP2, which will soon start to look at their next evolution, and where there may be some potential to introduce CPM into those future networks. Moreover, there is also a strong potential for the present invention to have applications in GSM to increase its spectral efficiency, since that system currently uses binary single-h CPM (via GMSK).

### The Transmitter/Receiver Node, Point or Element

FIG. 9a shows an example of a CPM transmitter generally indicated as 100 having a low complexity cyclic extension module 102 according to the present invention, as well as other transmitter modules 104. In operation, the low complexity cyclic extension module 102 appends a cyclic extension to a continuous phase modulation (CPM) block, wherein each information symbol and its antipodal counterpart is transmitted in any order within a data portion of the continuous phase modulation block, consistent with that shown and described herein.

FIG. 9b shows an example of a CPM receiver generally indicated as 200 having a low complexity cyclic extension module 202 according to the present invention, as well as other receiver modules 204. In operation, the low complexity cyclic extension module 202 processes the CPM transmission block received from the CPM transmitter, consistent with that shown and described herein.

### The Basic Receiver/Transceiver Functionality

The basic functionality of the CPM transmitter 100 and the receiver 200 according to the present invention may be implemented as follows:

By way of example, and consistent with that described herein, the functionality of the modules 102 and 202 may be implemented using hardware, software, firmware, or a combination thereof, although the scope of the invention is not intended to be limited to any particular embodiment thereof. In a typical software implementation, the module 102 and 202 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 102 and 202 being used as stand alone modules, as shown, or in the combination with other circuitry for implementing another module.

The other modules 104 and 204 and the functionality thereof are known in the art, do not form part of the underlying invention per se, and are not described in detail herein.

### Advantages/Disadvantages

Advantages of the present invention include the following:

1. The present invention circumvents the need for the transmitter to calculate tail or channel bits based on the past symbols, which implies that the complexity level is much lower than the state of the art.

2. Because the data block contains two copies of each symbol, the present invention may be used to improve receiver performance by exploiting the diversity of the received signal.

3. The new method and apparatus to cyclically extend CPM according to the present invention enables the use of low complexity SC-FDE techniques at the receiver.

4. The low complexity of the method and apparatus according to the present invention helps to remove some of the possible reservations against the use of CPM.

5. The present invention maintains the same level of transmitter complexity for all CPM variants (i.e. single-h, multi-h, binary, M-ary, etc.), while the state of the art solution increases in complexity/required memory allocation as the CPM waveform itself increases in complexity.

6. With the rising popularity of DFT-based SC-FDE techniques and the recent interest in extending these techniques to CPM waveforms, it should be expected that any future standard that incorporates CPM will construct specifications for how the transmitter should incorporate a cyclic extension into the CPM waveform. The present invention addresses that concern and could be easily used in a low-complexity, low-power mode for CPM data transmission.

One shortcoming of the present invention is that transmitting N/2 instead of N data symbols in each data block reduces the throughput by a factor of two. However, there may be situations in which the redundancy of the data actually improves the receiver performance, such as when the length of the channel exceeds the length of the cyclic extension. In addition, there are many well-known systems that use time domain spreading and/or frequency domain spreading (via conjugate symmetry) in their implementations. One example is the MBOA's (Multiband OFDM Alliance's) MB-OFDM (Multi-Band OFDM) UWB radio, which, in its 53.3, 55 and 80 Mbps data modes, sends each conjugate-symmetric OFDM symbol over two consecutive time slots.

This represents a spreading factor of 4. In addition, for all other data modes below 480 Mbps, the MBOA MB-OFDM UWB radio uses conjugate symmetry. This represents a spreading factor of 2. Hence, the loss in data rate should not be a deterrent to recognising the usefulness of this invention.

### List of Abbreviations

CPM: Continuous Phase Modulation

ISI: Inter-symbol interference

MBOA: MultiBand OFDM Alliance

MB-OFDM: Multiband OFDM

SC-FDE: Single Carrier Frequency Domain Equalisation

UWB: Ultrawideband

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method comprising:
appending a cyclic extension to a continuous phase modulation block; and
transmitting each information symbol and its antipodal counterpart in any order within a data portion of the continuous phase modulation block.

2. A method according to claim 1, wherein the continuous phase modulation block includes a sequence of N/2 M-ary information symbols that are spread over N symbol intervals.

3. A method according to claim 1, wherein the cyclic extension includes the first G M-ary symbols that are sent in the data portion of the block being appended to the continuous phase modulation block.

4. A method according to claim 1, wherein the cyclic extension is appended as a postfix at the end of the information sequence without disrupting the phase continuity of the waveform of the continuous phase modulation block.

5. A method according to claim 2, wherein the sequence includes over the first N/2 symbol intervals allowing the modulation index to cycle through its J values or to assume its values over the first N/2 symbol intervals according to rules that are predefined by a system specification, and over the next N/2 symbol intervals reversing the modulation indices.

6. A method according to claim 1, wherein the same modulation index is used for each information symbol and its antipodal counterpart.

7. A method according to claim 1, wherein the continuous phase modulation waveform has a phase argument that is constructed from the following symbols, their anti-podal counterparts, and the set of modulation indices:
{I₀, . . . , I_{N/2-1}}, {−I₀, . . . , −I_{N/2-1}}
{h₍₀₎_{_{J}}, . . . , h_{(N/2-1)}_{_{J}}}, {h₍₀₎_{_{J}}, . . . , h_{(N/2-1)}_{_{J}}}
where Iᵢ is an M-ary symbol from the sequence {I₀, . . . , I_{N/2-1}}, h₍ᵢ₎_{_{N}} ∈ {h₀, . . . , h_{J-1}} is a modulation index from the periodic sequence {h₀, . . . , h_{J-1}}, and the notation (i)_{J} denotes i modulus J.

8. (canceled)

9. A method according to claim 1, wherein the phase state returns to its initial value after N M-ary symbols have been sent.

10. A method according to claim 1, wherein the method is used in uplink signalling applications when battery power is an important concern.

11. A method according to claim 1, wherein the order is random.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A network node, point or element comprising:
a module configured to append a cyclic extension to a continuous phase modulation block in a wireless network, each information symbol and its antipodal counterpart being transmitted in any order within a data portion of the continuous phase modulation block.

24. A network node, point or element according to claim 23, wherein the continuous phase modulation block includes a sequence of N/2 M-ary information symbols that are spread over N symbol intervals.

25. A network node, point or element according to claim 23, wherein the cyclic extension includes the first G M-ary symbols that are sent in the data portion of the block being appended to the continuous phase modulation block.

26. A network node, point or element according to claim 23, wherein the cyclic extension is appended as a postfix at the end of the information sequence without disrupting the phase continuity of the waveform of the continuous phase modulation block.

27. A network node, point or element according to claim 24, wherein the sequence includes over the first N/2 symbol intervals allowing the modulation index to cycle through its J values or to assume its values over the first N/2 symbol intervals according to rules that are predefined by a system specification, and over the next N/2 symbol intervals reversing the modulation indices.

28. A network node, point or element according to claim 23, wherein the same modulation index is used for each information symbol and its antipodal counterpart.

29. A network node, point or element according to claim 23, wherein the continuous phase modulation waveform has a phase argument that is constructed from the following symbols, their anti-podal counterparts, and the set of modulation indices:
{I₀, . . . , I_{N/2-1}}, {−I₀, . . . , −I_{N/2-1}}
{h₍₀₎_{_{J}}, . . . , h_{(N/2-1)}_{_{J}}}, {h₍₀₎_{_{J}}, . . . , h_{(N/2-1)}_{_{J}}}
where Iᵢ is an M-ary symbol from the sequence {I₀, . . . , I_{N/2-1}}, h₍ᵢ₎_{_{N}} ∈ {h₀, . . . , h_{J-1}} is a modulation index from the periodic sequence {h₀, . . . , h_{J-1}}, and the notation (i)_{J} denotes i modulus J.

30. (canceled)

31. A network node, point or element according to claim 23, wherein the phase state returns to its initial value after N M-ary symbols have been sent.

32. A network node, point or element according to claim 23, wherein the continuous phase modulation block is used in uplink signalling applications when battery power is an important concern.

33. A network node, point or element according to claim 23, wherein the order is random.

34. A network node, point or element according to claim 23, wherein the network node, point or element is a continuous phase modulation transmitting device for transmitting the continuous phase modulation block.

35. A network node, point or element according to claim 23, wherein the network node, point or element is a continuous phase modulation receiving device for receiving the continuous phase modulation block.

36. A network node, point or element according to claim 23, wherein the network node, point or element forms part of a Metropolitan Area Network, or some other suitable network based on a Global System for Mobile communications, othogonal frequency division multiplexing or code division multiple access network configuration.

37. A computer-readable storage medium having computer-executable components for carrying out a method comprising appending a cyclic extension to a continuous phase modulation block; and transmitting each information symbol and its antipodal counterpart in any order within a data portion of the continuous phase modulation block.

38. A method according to claim 1, wherein the method further comprises implementing the method via a computer program running in a processor, controller or other suitable module in one or more network nodes, points, terminals or elements in the wireless network.

39. A wireless network according to claim 12, wherein the wireless network is a Metropolitan Area Network, as well as some other suitable network based on one or more of the Third Generation Partnership Project 2, Global System for Mobile communications, othoqonal frequency division multiplexing or code division multiple access network configurations.

40. A method according to claim 1, wherein the same modulation indices used for the first G-symbols of the data portion of the continuous phase modulation block are used for the cyclic extension.

41. A method according to claim 1, wherein the modulation index of the continuous phase modulation waveform is determined by the data being sent or other transmission rule.

42. A wireless network according to claim 12, wherein the same modulation indices used for the first G-symbols of the data portion of the continuous phase modulation block are used for the cyclic extension.

43. A wireless network according to claim 12, wherein the modulation index of the continuous phase modulation waveform is determined by the data being sent or other transmission rule.

44. A wireless node, point or element according to claim 23, wherein the same modulation indices used for the first G-symbols of the data portion of the continuous phase modulation block are used for the cyclic extension.

45. A wireless node, point or element according to claim 23, wherein the modulation index of the continuous phase modulation waveform is determined by the data being sent or other transmission rule.

46. Apparatus comprising:
means for appending a cyclic extension to a continuous phase modulation block; and
means for transmitting each information symbol and its antipodal counterpart in any order within a data portion of the continuous phase modulation block.

47. A module comprising:
one or more elements configured for appending a cyclic extension to a continuous phase modulation block and for transmitting each information symbol and its antipodal counterpart in any order within a data portion of the continuous phase modulation block.

48. A module according to claim 47, wherein the module forms part of a continuous phase modulation transmitter.
